(19) United States
(12) Patent Application Publication
(10) Pub. No.: US 2006/0047351 A1
(43) Pub. Date: Mar. 2, 2006

(54) Process controller output and alarm setting evaluation

(76) Inventor: Alan Hugo, Danville, CA (US)

Correspondence Address: Alan Hugo, 805 Waingarth Way, Danville, CA, 94526, US

(21) Appl. No.: 10/928,592

(22) Filed: Aug. 27, 2004

(51) Int. Cl. G05B 9/02

(52) U.S. Cl. 700/80; 700/81; 700/82

(57) ABSTRACT

A method for evaluating alarm settings and controller response time for continuous or semi-continuous processes that gives an indication of the ability of the controller to respond quickly enough to prevent alarms, and an indication of whether the alarm setting is within the normal operating region of the process. The technique requires only a history of alarm events, process measurements, and controller outputs.

### CROSS-REFERENCE TO RELATED APPLICATIONS

None

### STATEMENT REGARDING FEDERALLY SPONSORED RESEARCH AND DEVELOPMENT

N/A

### BACKGROUND

1. Field of the Invention

This invention relates to a technique to evaluate the relationship between alarm settings and controller outputs for continuous and semi-continuous processes.

### BACKGROUND

2. Discussion of Prior Art

Alarms are often applied to process measurements to indicate that an event has occurred, or is likely to occur in the near future. Many processes are controlled by automatic controllers, in which a controller changes its output (which is also an input to the process) in order to maintain a measurement at some desired value. It is often the case that the measurement has an alarm associated with it, such that if the measurement moves too far from the desired value, an alarm will trip.

One criterion for alarms is that they should indicate when there is an imminent upset condition and the automatic control system is no longer able to control the process. If an alarm occurs while the controller can still manipulate the process, it may due to one of two causes:
1. The controller tuning parameters or structure need to be changed so that the controller is more responsive (i.e., faster) to counteract upsets in the process.
2. The value of the alarm setting (i.e., the value of the measurement at which the alarm occurs) should be changed so that the alarm will not occur if the process is still in a region where the control system can automatically bring the process back to a stable condition.

An assumption is made in the first cause that the alarm setting is correct, and that the controller response needs to be examined. Conversely, the assumption in the second cause is that the controller is fast enough, but there is doubt as to whether the alarm setting is correct. It is also possible that neither of these is true—the controller may be manipulating the process as fast as possible (limited by stability constraints for instance) or that the alarm setting cannot be moved as it would not provide an operator of adequate warning.

The actual value of an alarm setting is generally set in an informal way—either by a designer or by an operator on the actual process unit. The designer knows the normal operation value and actual process constraint, and, based often on heuristics, sets the alarm value somewhere in between. The designer may or may not know the steady-state controllable range of the process, but generally does not know if a controller can respond fast enough to prevent an alarm for the range of possible disturbances. An operator may be more familiar with the process response, but is rarely considering this response in the context of controller tuning and alarm settings.

A typical processing plant may have hundreds of controllers and thousands of alarms. In most circumstances, there is minimal information available at design time to adequately determine either suitable alarm settings, or (although less often) controller tuning parameters or controller structure (both of which affects the rate of change of the controller output). However, once the plant has been running for a significant length of time, historical values of the controller output, process measurements, and alarm times may be used to evaluate the alarm settings and controller tuning parameters. Due to the large quantity of data, computer-aided techniques are required which can quickly search the historical archives to generate concise metrics and graphs which indicate the suitability of both the alarm settings and controller tuning parameters.

In theory, controllers are often designed and tuned such that they are as fast as possible subject to some subjective criteria such as stability or robustness. Often the financial or quality limitations associated with poor control are not recognized, and in practice the tuning or design may be sup-optimal so that the controller is sluggish. While there are several technologies that evaluate controllers in terms of how well they minimize the variance of the measurement (see U.S. Pat. Nos. 5,838,561; 6,459,939; 6,546,358), this may be of limited concern to many industries where variance is not an issue. However, the financial cost of alarms is recognized, and it would be of interest to these industries to determine if any alarms could be avoided by implementing a more responsive controller.

Discussion of alarm settings in relation to process controllability is mentioned in the widely used industrial guide Alarm Systems, A Guide to Design, Management, and Procurement, EEMUA, 1999. While the authors stress the importance of setting the alarms outside the region of normal process variation, they do not indicate any techniques for determining these regions. Furthermore, as the authors were concerned with alarms only, they do not take into whether controller tuning or structure may be modified to prevent an alarm.

Evaluation of alarm settings was discussed in U.S. Pat. No. 6,618,691, where the purpose was to determine the best alarm setting that would give an operator adequate warning without excessive “false” alarms (i.e., alarming during normal variation). However, this technique only looked at the alarm itself and the process measurement—no consideration was made of the controller output. It therefore did not consider if the controller was adequate, or if the process was still controllable when the alarm occurred.

Standard Statistical Quality Control (SQC) techniques can be used to ascertain whether a process is in an alarm condition (see for example U.S. Pat. No. 5,257,206), but these are generally concerned with process measurements, not controller outputs. Expert systems, such as in U.S. Pat. No. 5,493,729, or deterministic models as in U.S. Pat. No. 5,997,167, can take into account the controller output, but these are again used for determining whether the system is in alarm, and not whether a controller is responding adequately. They also require considerable effort for each alarm or controller, and are therefore not suited for evaluating the effectiveness of large number of controllers and/or alarm settings.

### BRIEF SUMMARY OF THE INVENTION

It is a feature of the present invention to provide a method to determine the effectiveness of a control system for a continuous or semi-continuous process before and when an alarm occurs. Another feather of the present invention is that it is also a method to determine whether an alarm occurs within the controllable region of the process. It is, also, a feature of the present invention that it only requires normal operating data to determine these factors. Yet another feature of the present invention is that it requires minimal user input or configuration to determine these factors.

The techniques of this invention do not require a deterministic model as statistical models are constructed solely from databases of historical plant behavior. Further, it is not an objective of this invention to model the behavior of the process or to determine whether a process should be in an alarm state, but more strictly to determine whether the current alarm setting is acceptable, and whether a controller applied to the process should be modified.

Additional features and advantages of the invention will be set forth in part in the description that follows, and will in part be apparent from the description, or may be learned from practice of the invention. The features and advantages of the invention may be realized by means of the combinations and steps pointed out in the appended claims.

Accordingly, objects and advantages of the present invention are:
a) to determine whether a controller for continuous and semi-continuous processes responds fast enough to prevent alarms;
b) to determine whether alarms settings for continuous and semi-continuous processes are set within the controllable region of the process.

Further objects and advantages are that the inventions requires only historical data to determine the above, and may be quickly applied to a large number of alarms and controllers.

### BRIEF DESCRIPTION OF THE DRAWINGS

The above and other objects, features and advantages of the present invention will become apparent from the following description and the appended claims, taken in conjunction with the accompanying drawings in which:

FIG. 1 is a typical representation of a controller output histogram that is generated by the present invention, representing the distribution of the controller output value at the time of the alarm occurrences.

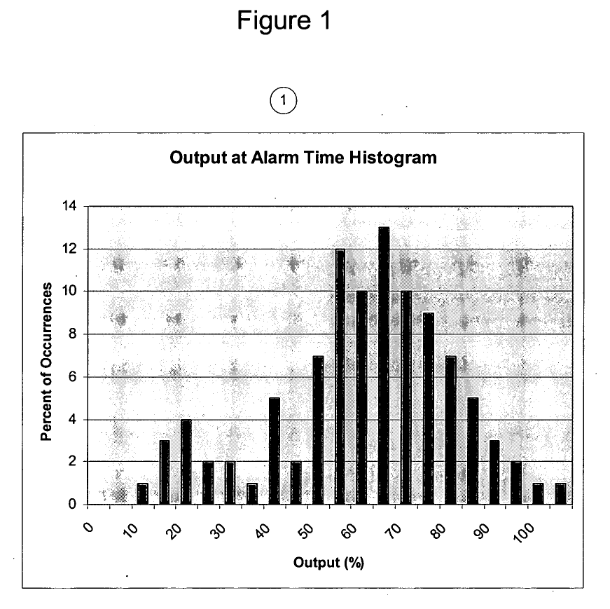

FIG. 2 is a typical representation of an average process measurement and average controller output vs. time trend that is generated by the present invention.

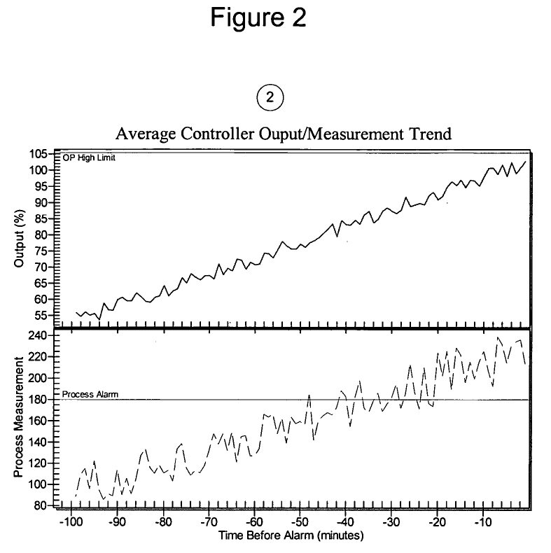

FIG. 3 is a flow chart for the methodology of this patent application.

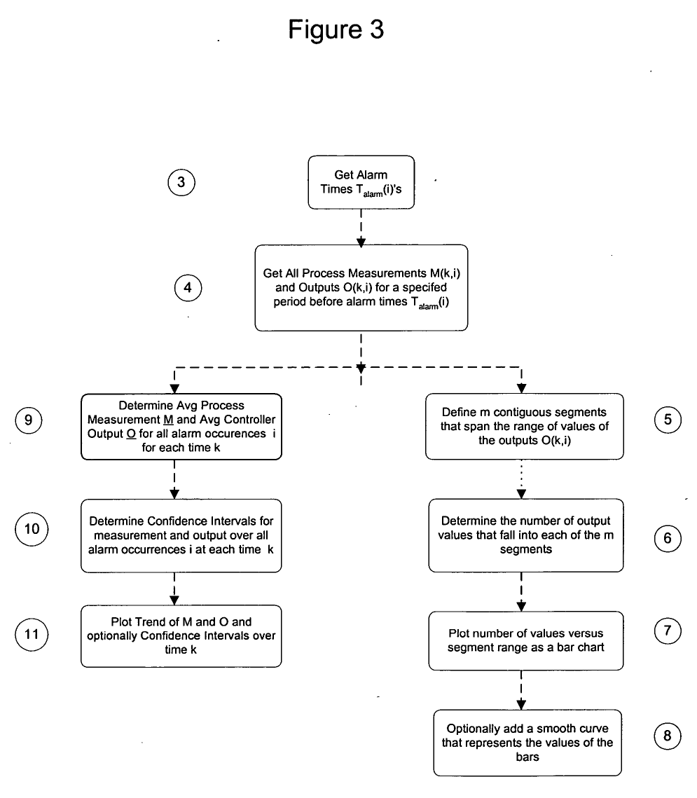

FIG. 4 is a schematic illustration of the computer system used to calculate the histogram and trend in accordance with the present invention. The generation and construction is performed in a program in the general purpose computer.

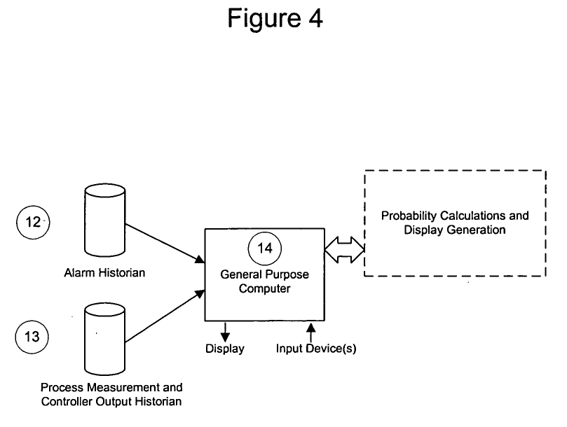

### DETAILED DESCRIPTION OF THE INVENTION

The determination of desirable alarm settings using historical data requires historized values of the alarm time and setting 12, as well as historized values of the process measurement and controller output on which the alarm is based 13. From this data, a histogram and trend may be generated and drawn using a general purpose computer 14.

The histogram 1 indicates the distribution of the controller output at the times that a process measurement equals its alarm setting. The trend 2 indicates the average values of the process measurement and controller output as a function of time for a given length of time before (and possibly after) alarm occurrences.

The histogram is generated by obtaining a set of all alarm times 3 for a specified alarm, along with historized values of the controller output 4 for a specified time frame before and after each of the alarms. It is assumed that the controller output can have some affect on the occurrence and/or time of the alarm, and that a user is aware of this relationship. The alarm and controller output may all be for the same tag (i.e., the alarm may be for a specified value of the process measurement, and the controller output is used to control the process measurement), or they may be for separate tags.

To generate the histogram, the range of values of the controller output is determined, then a set of numbers are generated, with each member of the set representing a fraction of the controller output range 5. For each member of the set, the number of the controller output values that fall into that fraction is determined 6. These values are plotted on a chart, with the ordinate representing the count and the abscissa representing the range 7. Optionally, a line representing smoothed values may also be plotted on the same or a different chart 8.

The trend diagram is largely a standard trend, in that it displays a continuous value as a function of time. However, in this case the continuous value is the average of a set of controller outputs and process measurements 9, where each controller output and process measurement is for the time range immediately preceding an alarm. Optionally, confidence intervals are also calculated 10, which give an indication of the range of the data values. These values are plotted, with the averages and confidence intervals are plotted as the ordinate, and the time before the alarm in plotted as the abscissa 11.

### Additional Embodiments

1) The results may be represented as text or numbers rather than graphically.
2) The histogram may be smoothed using a suitable mathematical technique or calculated using a different method.
3) The distribution of controller outputs before an alarm may be represented in some other form than a histogram.
4) The average of the process measurement and/or average of the controller output trend may be replaced by trends of the individual components that make up the averages.
5) Confidence intervals for the process measurement and/or controller output may be superimposed on the trends.
6) For a given set of distinct alarms and controller outputs, the invention may be constructed to give a list of all distinct alarms and controller outputs where the controller output was not at a high or low limit at the time of alarm.
7) Other visual (such as color) or audible systems may be used to indicate distribution of the controller output.
8) The algorithm may be formulated so that the results are updated automatically each time an alarm occurs.
9) The technique may be used in an on-line method where the results are automatically updated on a scheduled or event basis and the results presented to a user in real-time.
10) The methodology may be used with rate-of-change alarms instead of absolute alarm values.
11) Additional information such as other measurements may be used to calculate the results.

### CONCLUSIONS, RAMIFICATIONS, AND SCOPE

Accordingly, the reader will see that the method described herein is able to ascertain both whether a controller is able to respond fast enough to prevent an alarm, and whether an alarm setting is within the controllability region of the process. This method requires only a history of the alarm occurrences, process measurements, and controller outputs.

Although the description above contains many specificities, these should not be construed as limiting the scope of the invention but as merely providing illustrations of some of the preferred embodiments of the invention.

Thus the scope of the invention should be determined by the appended claims and their legal equivalents, rather than the derivations given.

1. A novel method for evaluating the setting of an existing alarm and/or the response of an existing controller applied to a continuous or semi-continuous process, the method comprising:
a. steps for retrieving a set of historical records of past alarm values and associated times and past process measurements and associated times and past controller outputs and associated times;
b. steps for calculating a distribution of said controller output values for a specified period of time before the said alarm times from said historical record of past alarm times and said past controller outputs;
c. steps for calculating a trend, where the abscissa values represent the relative time before the said alarm times, and the ordinate values represent a representation of the said process measurements and said controller outputs at the corresponding relative time;
d. steps for displaying the said distribution and said trend, either in numerical or graphical form,
whereby said distribution indicates both the effectiveness of the said controller outputs on the said alarm values, and whether the said alarm values are effective for the said process, and
whereby said trend indicates the behavior of the said process prior to the said alarm times.
